(19) United States
(12) Patent Application Publication
(10) Pub. No.: US 2017/0325924 A1
(43) Pub. Date: Nov. 16, 2017

(54) DENTAL DEVICE

(71) Applicants: Julie Lezotte, Rochester, MI (US); Angela Dekock, Rochester, MI (US); Jessica Gaul, Birmingham, MI (US)

(72) Inventors: Julie Lezotte, Rochester, MI (US); Angela Dekock, Rochester, MI (US); Jessica Gaul, Birmingham, MI (US)

(21) Appl. No.: 15/155,326

(22) Filed: May 16, 2016

(51) Int. Cl. A61C 19/06

(52) U.S. Cl. CPC A61C 19/066

(57) ABSTRACT

A dental device having a set of overlays wherein each overlay is dimensioned to cover a front surface of a selected human tooth so that at least one surface of the front teeth of the human are covered. An adhesive is mounted to at least a portion of the rear surface of each overlay, which may be mono or multiple layer, to secure the overlay to its associated tooth. The liners may function as cosmetic devices as well as drug delivery devices.

### I. FIELD OF THE INVENTION

The present invention relates generally to dental devices and, more particularly, to a set of overlays for the teeth.

### II. DESCRIPTION OF RELATED ART

Human teeth, while initially whitish in color, oftentimes become discolored with age. Even though some activities, such as smoking and eating certain foods, may increase the degree of discoloration of the human teeth, as a practical matter most human teeth will become discolored from their initial white color over time.

There are a number of different treatments which decrease the amount of discoloration of the human teeth. For example, a bleaching compound is oftentimes used to remove, or at least decrease, the amount of staining on the human teeth. Oftentimes the teeth whitening treatments are also available to whiten the human teeth. All these treatments, however, suffer certain disadvantages.

First, these previously known treatments are only partially successful in whitening the human teeth. As such, human teeth that have undergone such whitening processes are oftentimes still discolored relative to the original white color of the human teeth.

A still further disadvantage of these previously known treatments is that such treatments are expensive to perform. In many cases, only a professional, such as a dentist, is able to perform the teeth whitening operation.

Lastly, such previously known teeth whitening procedures only enjoy temporary success and must be frequently repeated. Furthermore, such teeth whitening procedures are oftentimes expensive to obtain.

### SUMMARY OF THE PRESENT INVENTION

The present invention provides a dental device which provides temporary tooth whitening. In brief, the dental cosmetic device of the present invention includes a set of overlays wherein each overlay is dimensioned or presized to cover a front surface of a selected tooth. As such, the overlays will be of a different size for different teeth in the human mouth. Furthermore, the overlays are preferably constructed of a material which may easily be trimmed by the user to the shape of the human teeth. In addition, the dental device may function as a drug delivery device.

Any conventional material may be used to form the overlays. However, preferably the overlays are constructed of a polymer material for low cost and yet long durable in use.

The front or outwardly facing side of the overlays is preferably white. However, alternatively, the overlays may be different colors or even have patterns, words, symbols, images, designs, embellishments, and permissive use of trademarks which may be desired by the user.

The overlays are attached to the front surface of the teeth so that the overlays cover the front surface of at least those teeth that are visible. Preferably, the overlays are made of a flexible material, such as polymer, which may be easily trimmed so that each overlay completely covers its associated tooth.

In order to attach the overlays to the teeth, a rear surface of each overlay is at least partially coated with an adhesive. Consequently, in order to apply the overlays to the teeth, the user simply presses the overlay against the tooth so that the adhesive engages the tooth and secures the overlay to the tooth.

Once the overlays are secured to the teeth, the overlays may optionally be trimmed to fit their associated teeth. Furthermore, when no longer desired, the overlays are simply removed from the tooth and either saved for future use, or discarded.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a diagrammatic view illustrating a preferred embodiment of the present invention prior to attachment of the dental devices to their associated teeth;

FIG. 2 is a view similar to FIG. 1, but illustrating the overlays attached to their associated teeth; and

FIG. 3 is a sectional view taken substantially along line 3-3 in FIG. 2 and enlarged for clarity.

### DETAILED DESCRIPTION OF A PREFERRED EMBODIMENT OF THE PRESENT INVENTION

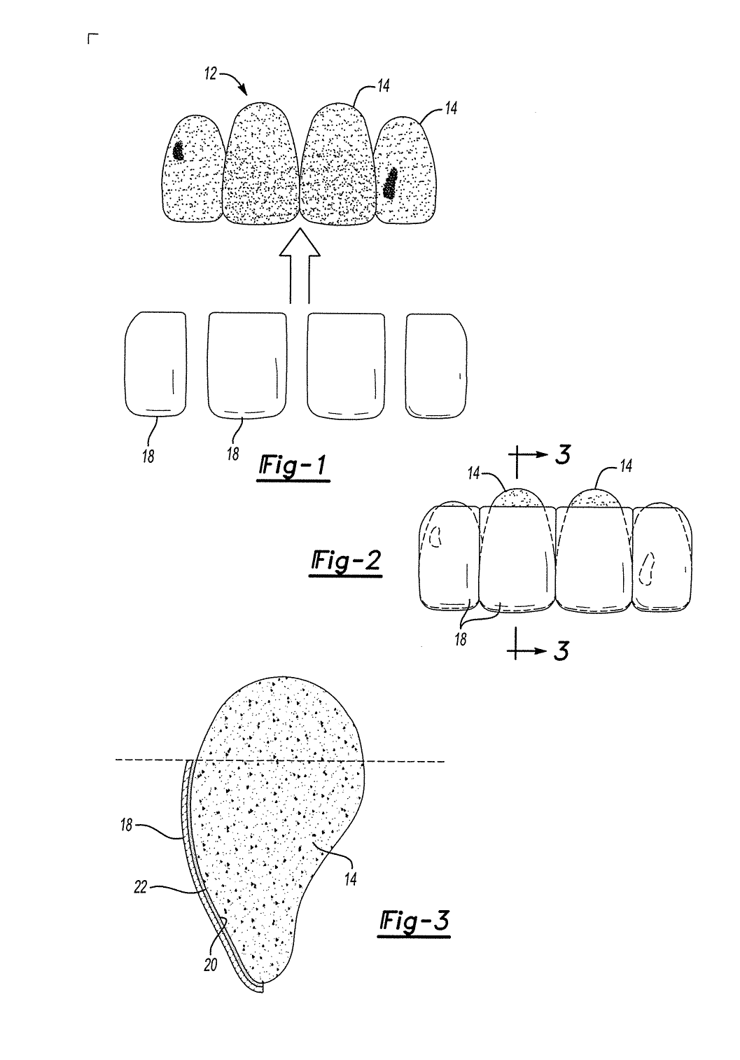

With reference first to FIG. 1, a preferred embodiment of the dental cosmetic cover 10 according to the present invention is shown for use with a set of human teeth 12. Only a portion of the upper section of the human teeth 10 is illustrated in the drawing, it being understood that a like description shall also apply to the remaining teeth.

As best shown in FIG. 1, the human teeth 12 include a number of individual teeth 14 which vary in size not only between the different teeth, but also from one person to the next. Each tooth 14, however, generally includes a front surface 16 that is visible to the public. Furthermore, the different teeth 14 vary in size depending upon the location of the teeth in the user's mouth.

Referring now to FIGS. 1 and 2, the present invention includes a plurality of thin overlays 18 wherein each overlay 18 is dimensioned to cover one of the teeth 14 of the user. Consequently, the overlays 18 will vary in size depending upon their associated tooth 16.

The overlays 18 are preferably constructed of a thin, flexible plastic material. As such, each overlay, when positioned against its associated tooth 14, will generally flatly abut against its associated tooth 14. The overlays 18, furthermore, may be trimmed as required by scissors or a knife to fit their associated tooth 16 of the user.

The overlays 18, furthermore, are preferably constructed of a thin, flexible plastic material so that the overlays 18 each flatly abuts against its associated tooth 14. The overlays 18 are preferably made of a thin plastic material for durable yet inexpensive construction. Other materials, however, may alternately be used without deviation from the spirit or scope of the invention.

With reference now to FIG. 3, a rear surface 20 of each overlay 18 is at least partially covered, and preferably completely covered, with an adhesive material 22. The adhesive material 22 preferably covers the entire rear facing surface of the overlays 18 although, if desired, the rear surface of the overlays 18 may be only partially covered by the adhesive 22. Furthermore, the adhesive 22 is selected so that, not only is it waterproof, but also retains the overlay 18 on its associated tooth 14 while in use.

Preferably, the adhesive covers the entire side of its associated overlay. Alternatively, however, only a portion of the overlay is covered with the adhesive 22.

If it is desired to remove the overlays from the teeth 14, the overlays 18 are merely pried away from their associated tooth 14 and either saved for future use, or discarded.

Preferably, the overlays 18 are constructed of a tooth colored, white polymer, such as plastic, to simulate the appearance of teeth. Alternatively, however, the overlays 18 may include any and all colors, patterns, designs, embellishments, and permissive use of trademarks in order to achieve a desired cosmetic effect.

From the foregoing, it can be seen that the present invention provides a simple, yet effective cosmetic dental device. Having described our invention, however, many modifications thereto will become apparent to those skilled in the art to which it pertains without deviation from the spirit of the invention as defined by the scope of the appended claims.

We claim:

1. A dental device comprising:
a set of overlays, each overlay dimensioned to cover a front surface of a selected human tooth, and
an adhesive mounted to at least a portion of one surface of each overlay.

2. The dental device defined in claim 1 wherein said adhesive covers at least a portion of a back of its associated overlay.

3. The dental device defined in claim 2 wherein said adhesive covers substantially the entire back of its associated overlay.

4. The dental device defined in claim 3 wherein said adhesive is water resistant.

5. The dental device defined in claim 1 wherein said overlay comprises a flexible sheet.

6. The dental device defined in claim 5 wherein said sheet comprises a synthetic material.

7. The dental device defined in claim 5 wherein said sheet comprises a polymeric material.
